(19) United States
(12) Patent Application Publication
(10) Pub. No.: US 2009/0274912 A1
(43) Pub. Date: Nov. 5, 2009

(54) MULTILAYER STRUCTURE HAVING A GRAFTED POLYVINYLIDENE FLUORIDE BLEND LAYER

(75) Inventor: Anthony Bonnet, Beaumont Le Roger (FR)

Correspondence Address: ARKEMA INC.;PATENT DEPARTMENT - 26TH FLOOR, 2000 MARKET STREET, PHILADELPHIA, PA, 19103-3222, US

(73) Assignee: ARKEMA FRANCE, Colombes (FR)

(21) Appl. No.: 12/297,925

(22) PCT Filed: Apr. 19, 2007
(86) PCT No.: PCT/IB2007/052680

§ 371 Date: Jun. 2, 2009

Related U.S. Application Data
(60) Provisional application No. 60/793,986, filed on Apr. 21, 2006.

(51) Int. Cl. B32B 27/28

(52) U.S. Cl. 428/422; 428/421

(57) ABSTRACT

The invention relates to a multilayer structure comprising a layer of blend based on a fluoropolymer, onto which an unsaturated monomer has been grafted by irradiation, and a layer of a thermoplastic polymer. The structure may for instance be used for storing and transporting Chemicals. More precisely, this structure comprises at least one layer of a blend of at least one functionalized fluoropolymer and at least one flexible fluoropolymer having a tensile modulus between 50 and 1000 MPa (as measured according to ISO R 527 at 23° C.) and at least one layer of a polyolefin.

### FIELD OF THE INVENTION

The present invention relates to a multilayer structure comprising a layer of blend based on a fluoropolymer, onto which an unsaturated monomer has been grafted by irradiation, and a layer of a thermoplastic polymer. The structure may for instance be used for storing and transporting chemicals. More precisely, this structure comprises at least one layer of a blend of at least one functionalized fluoropolymer and at least one flexible fluoropolymer having a tensile modulus between 50 and 1000 MPa (as measured according to ISO R 527 at 23° C.) and at least one layer of a polyolefin. This structure may, for example, be in the form of bottles, tanks, pipes or containers. The term “chemicals” is understood in the present invention to mean corrosive or dangerous products or even products whose purity has to be maintained, and therefore which must not be contaminated by the tank in which they are stored. These structures may be manufactured by rotomoulding, extrusion or extrusion blow moulding. These techniques are known per se.

### PRIOR ART AND THE TECHNICAL PROBLEM

Fluoropolymers, for example those based on vinylidene fluoride CF2=CH2 (VDF) such as PVDF (polyvinylidene fluoride) are known to provide excellent mechanical stability properties, very high chemical inertness and good ageing resistance. However, this chemical inertness of fluoropolymers means that it is difficult to bond them or to combine them with other materials. We have found that a blend of at least one functionalized fluoropolymer and at least one flexible fluoropolymer having a tensile modulus between 50 and 1000 MPa provides very good adhesion onto various thermoplastic polymers.

### BRIEF DESCRIPTION OF THE INVENTION

The term fluoromonomer refers to an unsaturated monomer of formula (I):

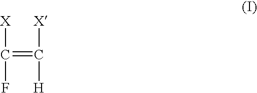

in which X and X′ can be, independently of one another, a hydrogen atom, a halogen, in particular fluorine or chlorine, or a perhalogenated, in particular perfluorinated, alkyl.

Suitable exemplary fluoromonomers for use according to the invention include, but are not limited to, vinylidene fluoride (VDF, CH₂═CF₂), vinyl fluoride, trifluoroethylene, tetrafluoroethylene (TFE), hexafluoropropylene (HFP) and chlorotrifluoroethylene (CTFE) and mixtures thereof. Mention may also be made of, 2-chloropentafluoro-propene, perfluoroalkyl vinyl ethers, such as CF₃—O—CF═CF₂ or CF₃—CF₂—O—CF═CF₂, 1-hydropentafluoropropene, 2-hydropentafluoropropene, dichlorodifluoroethylene, 1,1-dichlorofluoroethylene and perfluoro-1,3-dioxoles, such as those described in U.S. Pat. No. 4,558,142. Fluorine-comprising diolefins can be mentioned as well, for example diolefins, such as perfluorodiallyl ether and perfluoro-1,3-butadiene. Alkyl means an alkyl group having from 1 to 6 carbon atoms.

The term fluoropolymer refers to polymer and copolymers (including polymers having two or more different monomers, such as terpolymers) containing at least 50 mole percent of fluoromonomer units derived from fluoromonomer (I). The polymers and copolymers are obtained by the radical polymerization of at least one fluoromonomer of formula (I). Unsaturated olefinic monomers not comprising fluorine, such as ethylene, propylene, butylene and higher homologues, may also be used as comonomers.

The fluoropolymer is produced by processes known in the state of the art. The fluoropolymer can be prepared in aqueous emulsion or in aqueous suspension. The emulsion comprise, for example, a water-soluble initiator, such as an alkali metal or ammonium persulfate or an alkali metal permanganate, which produce free radicals, and also comprise one or more emulsifiers, such as alkali metal or ammonium salts of a perfluorooctanoic acid. Other aqueous colloidal suspension processes use initiators which are essentially soluble in the organic phase, such as dialkyl peroxides, alkyl hydroperoxides, dialkyl peroxydicarbonates or azoperoxides, the initiator being used in combination with colloids of the following types: methylcelluloses, methylhydroxypropylcelluloses, methylpropylcelluloses and methylhydroxyethyl-celluloses. In particular, U.S. Pat. No. 3,553,185 and EP 0120524 disclose processes for the synthesis of PVDF by suspending VDF in water and polymerizing it. U.S. Pat. No. 4,025,709, U.S. Pat. No. 4,569,978, U.S. Pat. No. 4,360,652, U.S. Pat. No. 626,396 and EP 0 655 468 disclose processes for the synthesis of PVDF by emulsifying VDF in water and polymerizing it.

In one embodiment, the fluoropolymer is a PVDF, that is a homo- or copolymer of VDF containing at least 50 mole % VDF, advantageously at least 75% VDF by weight and preferably at least 85% VDF. PVDF is preferred as it provides very good chemical and thermomechanical resistance and it is easily extruded. As regards the PVDF copolymers, they are obtained through the copolymerization of VDF and at least one comonomer selected from the group consisting of vinyl fluoride, trifluoroethylene, tetrafluoroethylene (TFE), hexafluoropropylene (HFP), chlorotrifluoroethylene (CTFE), 2-chloropentafluoro-propene, perfluoroalkyl vinyl ethers, such as CF₃—O—CF═CF₂ or CF₃—CF₂—O—CF═CF₂, 1-hydropentafluoropropene, 2-hydropenta-fluoropropene, dichloro-difluoroethylene, 1,1-dichlorofluoroethylene and perfluoro-1,3-dioxoles, such as those described in U.S. Pat. No. 4,558,142. Fluorine-comprising diolefins can be mentioned as well, for example diolefins, such as perfluorodiallyl ether and perfluoro-1,3-butadiene. Alkyl means an alkyl group having from 1 to 6 carbon atoms.

The PVDF can be a homopolymer or a copolymer of VDF and HFP or a terpolymer of VDF, HFP and TFE. For example, the PVDF is a homopolymer or a VDF/HFP copolymer.

The PVDFs commercialized under the brand name KYNAR® can be used. For example, we mention more particularly the following products: KYNAR 710, KYNAR 720, KYNAR 740, KYNAR 2850 and KYNAR 3120.

In the specification, the expression “unmodified fluoropolymer” is used to denote a fluoropolymer that has not been modified by radiation grafting. The definition of the term fluoropolymer applies equally for both the “unmodified fluoropolymer” and the fluoropolymer from which the radiation grafted fluoropolymer is derived.

As regards the functionalized fluoropolymer, it is any fluoropolymer comprising at least one fluoromonomer and at least one functional monomer having at least one double bond C═C and at lest one functional group that may be one or several groups of the following groups: a carboxylic acid, a carboxylic acid salt, a carbonate, a carboxylic acid anhydride, an epoxide, a carboxylic acid ester, a silyl, an alkoxysilane, a carboxylic amide, a hydroxyl, an isocyanate.

The functionalized fluoropolymer may be prepared in suspension, in emulsion or in solution by copolymerizing at least a fluoromonomer with said at least one functional monomer and optionally at least another comonomer. For instance, it may be a PVDF comprising monomer units of VDF and of an unsaturated dibasic acid monoester or vinylene carbonate as is envisioned in U.S. Pat. No. 5,415,958. Another example is a functionalized PVDF comprising monomer units of VDF and of itaconic or citraconic anhydride as is envisioned in U.S. Pat. No. 6,703,465 B2. Such functionalized PVDFs may be prepared in suspension, in emulsion or in solution.

The functionalized fluoropolymer may also be fluoropolymer that has been chemically modified by radiation grafting. The grafting is carried out in the bulk of the polymer and not on its surface according to the following process:
a) melt-blending a fluoropolymer and at least one graftable compound;
b) the blend obtained is made in the form of granules or powder;
c) irradiating this blend in the solid state by irradiation (which can be a γ or β radiation) with a dose of between 1 and 15 Mrad, optionally after having removed the residual oxygen; and
d) optionally removing the graftable compound that has not grafted and the residues liberated by the grafting, especially HF.

The blend is obtained by any melt blending techniques known in the art, preferably using an extruder.

The irradiation is done with an electron or photon source. The radiation dose is between 10 and 200 kGray, preferably between 10 and 150 kGray. Irradiation using a cobalt bomb is preferred. During step c), it is preferable to prevent oxygen from being present, for instance by flushing the fluoropolymer/graftable compound blend with nitrogen or argon.

The graftable compound is grafted in an amount of 0.1 to 5% by weight (i.e. the grafted graftable compound corresponds to 0.1 to 5 parts per 99.9 to 95 parts of fluoropolymer), advantageously 0.5 to 5% and preferably 1 to 5%. The content of grafted graftable compound depends on the initial content of the graftable compound in the fluoropolymer/graftable compound blend to be irradiated. It also depends on the grafting efficiency, and therefore on the duration and the energy of the irradiation.

Step d) can sometimes be optional if the amount of graftable compound that has not been grafted is low or not detrimental to the adhesion of the modified fluoropolymer.

Step d) may be carried out using techniques known to those skilled in the art. Vacuum degassing may be applied, optionally heating at the same time. It is also possible to dissolve the modified fluoropolymer in a suitable solvent, such as for example N-methylpyrrolidone, and then to precipitate the polymer in a non-solvent, for example in water or else in an alcohol.

One of the advantages of this radiation grafting process is that it is possible to obtain higher contents of grafted graftable compound than with conventional grafting processes using a radical initiator. Thus, typically, with the radiation grafting process it is possible to obtain contents of greater than 1% (1 part of graftable compound per 99 parts of fluoropolymer), or even greater than 1.5%, whereas with a conventional grafting process carried out in an extruder the content is lower and sometimes is not feasible.

The radiation grafting takes place “cold”, typically at temperatures below 100° C., or even below 70° C., so that the fluoropolymer/graftable compound blend is not in the melt state, as in the case of a “conventional” grafting process that is carried out in an extruder. One essential difference with a “conventional” grafting process is therefore that, in the case of a semicrystalline fluoropolymer (as is the case with PVDF for example), the grafting takes place in the amorphous phase and not in the crystalline phase, whereas homogeneous grafting is produced in the case of grafting carried out in an extruder. The graftable compound is therefore not distributed among the fluoropolymer chains in the same way in the case of radiation grafting as in the case of grafting carried out in an extruder. The modified fluoropolymer product therefore has a different distribution of the graftable compound among the fluoropolymer chains compared with a product that would be obtained by grafting carried out in an extruder. This makes it possible to obtain better adhesion properties than grafting using a radical initiator.

Preferably, the functionalized fluoropolymer is prepared from a PVDF, more preferably a PVDF whose viscosity (measured at 230° C. at a shear rate of 100 s⁻¹ using a capillary rheometer) ranges from 100 Pa·s to 1500 Pa·s, preferably from 200 to 1000 Pa·s and even more preferably from 500 to 1000 Pa·s.

With regard to the graftable compound, this possesses at least one double bond C═C, and at least one functional group that may be one of the following polar functional groups:
a carboxylic acid;
a carboxylic acid salt;
a carboxylic acid anhydride;
an epoxide;
a carboxylic acid ester;
a silyl;
an alkoxysilane;
a carboxylic amide;
a hydroxyl;
an isocyanate.

It is also possible to envisage mixtures of several graftable compounds.

As examples of graftable compounds (i.e. functional monomers), we mention methacrylic acid, acrylic acid, undecylenic acid, zinc, calcium or sodium undecylenate, maleic anhydride, dichloromaleic anhydride, difluoromaleic anhydride, itaconic anhydride, citraconic anhydride, crotonic anhydride, glycidyl acrylate, glycidyl methacrylate, allyl glycidyl ether and vinylsilanes, such as vinyltrimethoxysilane, vinyltriethoxysilane, vinyltriacetoxysilane and gamma-methacryloxypropyltrimethoxy-silane.

Preferably, to obtain good adhesion, an anhydride or else zinc, calcium or sodium undecylenates will be chosen. These graftable compounds also have the advantage of being solids, which makes it easier to introduce them into an extruder. Maleic anhydride is most particularly preferred as it allows good adhesion properties to be achieved.

Because of the presence of a C═C double bond in the graftable compound, polymerization of the graftable compound, to give polymer chains either grafted onto the fluoropolymer, or free chains, that is to say those not attached to the fluoropolymer, is not excluded. The term “polymer chain” is understood to mean a chain-linking of more than ten units of the graftable compound. Within the context of the invention, it is preferable to limit the presence of grafted or free polymer chains, and therefore to seek to obtain chains with fewer than ten units of the graftable compound. Chains limited to fewer than five graftable compound units will be preferred, and those having fewer than two graftable compound units will be even more preferred. Grafting only one compound unit is most preferred.

Likewise, it is not excluded for there to be more than one C═C double bond in the graftable compound. Thus, for example, graftable compounds such as allylmethacrylate, trimethylolpropane trimethacrylate or ethylene glycol dimethacrylate may be used. However, the presence of more than one double bond in the graftable compound may result in crosslinking of the fluoropolymer, and therefore in a modification of the rheological properties, or even the presence of gels, which is not desirable. It may then be difficult to obtain a high grafting efficiency while still limiting crosslinking. Thus, the graftable compounds containing only a single C═C double bond are preferred. The preferred graftable compounds are therefore those possessing a single C═C double bond and at least one polar functional group.

From this standpoint, maleic anhydride and also zinc, calcium and sodium undecylenates constitute good graftable compounds as they have little tendency to polymerize or even to give rise to crosslinking. Maleic anhydride is most particularly preferred.

As regards the flexible fluoropolymer, this relates to a fluoropolymer selected in the list given above having a tensile modulus between 50 and 1000 MPa (included boundaries) (as measured according to ISO R 527 at 23° C.), for example between 100 and 750 MPa (included boundaries) and even more preferably between 200 and 600 Mpa (included boundaries).

In one embodiment, the viscosity of the flexible fluoropolymer (measured at 230° C. at a shear rate of 100 s⁻¹ using a capillary rheometer) is from 100 to 1500 Pa·s, preferably from 200 to 1000 Pa·s and even more preferably from 500 to 1000 Pa·s.

In one embodiment, the crystallization temperature of the flexible fluoropolymer (measured by DSC according to ISO 11357-3) is selected from 50 to 120° C., more preferably from 85 to 110° C.

As regards the blend that is used in the present invention comprises at least one functionalized fluoropolymer and at least one flexible fluoropolymer. Preferably, the blend comprises by weight from 1 to 99 parts, advantageously from 10 to 90 parts, preferably from 10 to 75 parts, even more preferably from 10 to 50 parts of at least one functionalized PVDF per 99 to 1, advantageously from 90 to 10 parts, preferably from 90 to 25 parts, even more preferably from 90 to 50 parts of a flexible fluoropolymer.

As regards the thermoplastic polymer, this can be chosen among polyethylenes, polypropylene, polyurethanes, polyamides, including polyamides 6, 6.6, 6. 10, 6. 12, 11 and 12, polyethylene terphthalate, polybutylene terephthalate, polyphenylene sulphide, polyoxymethylene (acetal) or ethylene/vinyl alcohol copolymers, including blends and co-polymers thereof.

### Multilayer Structures

According to a first embodiment, the present invention relates to a multilayer structure comprising in succession:
a layer comprising the blend and,
a layer comprising a thermoplastic polymer.
   or a multilayer structure comprising in succession:
a layer comprising the blend and,
an outer layer comprising a thermoplastic polymer and
a layer comprising the blend.

In the case of tubes, pipes or hollow bodies like containers, the structure comprises in succession:
an inner layer comprising the blend and,
an outer layer comprising a thermoplastic polymer;
   or a multilayer structure comprising:
an inner layer comprising the blend and,
an intermediate layer comprising a thermoplastic polymer and
an outer layer comprising the blend.

Such structures, like fuel hoses, can be used as bodies for transporting or storing chemicals or fuels. The layer of the blend provides a permeability lower thanlgms/m2/day.

According to a variant, the structure comprises a fluoropolymer layer placed beside at least one of the layer of the blend opposite to the layer of the thermoplastic polymer. That is to say the structure comprises in succession a
a layer comprising a fluoropolymer,
a layer comprising the blend and,
directly attached to the latter, a layer comprising a thermoplastic polymer.

The layer comprising the fluoropolymer may be the inner or outer layer. The layer of the blend is a tie layer between the PVDF layer and the layer of the thermoplastic polymer.

In the above structures, it is possible to place, between the layer of the blend and the layer of the thermoplastic polymer (or layers), a tie-layer that adheres to the layer of the thermoplastic polymer and having functional groups capable of reacting with the functional groups of the functionalized fluoropolymer. It may for instance be a functionalized polyolefin having functional groups capable of reacting with the functional groups of the functionalized fluoropolymer. For example, if maleic anhydride has been grafted onto the fluoropolymer, the functionalized polyolefin layer may consist of a copolymer of ethylene, glycidyl methacrylate and optionally an alkyl acrylate, optionally as a blend with polyethylene.

In one embodiment, the structure of the invention comprises in succession:
an inner layer of PVDF,
optionally a layer comprising the blend,
a tie-layer,
an intermediate layer comprising a thermoplastic polymer,
a tie-layer,
an layer comprising the blend, and
optionally an outer layer of PVDF.

In the above structures, each of the layer may contain carbon black, carbon nanotubes or any other additive capable of making the said layer conductive in order to prevent the accumulation of static electricity.

These structures may be manufactured by rotomoulding, extrusion or extrusion blow moulding. These techniques are known per se.

### Examples of Multilayer Structures

A pipe or a container having in order the following layers:
PVDF (inner layer)/blend/tie-layer/polyethylene or polyamide/tie-layer/blend/PVDF (outer layer)

The PVDF layers can be optional so that the pipe is the following:
blend (inner layer)/tie-layer/polyethylene or polyamide/tie-layer/blend (outer layer)

The pipe can be used for transporting fuel (fuel hose). The container can be used for storing chemicals.

The tie-layer can be a functionalized polyolefin comprising epoxyde groups able to react with the groups on the functionalized fluoropolymer of the blend.

1. A multilayer structure comprising at least one layer of a blend of at least one functionalized fluoropolymer and at least one flexible fluoropolymer having a tensile modulus between 50 and 1000 Mpa, and at least one layer of a polyolefin.

2. Multilayer structure according to claim 1, wherein said fluoropolymer is obtained by the radical polymerization of at least one fluoromonomer of formula (I) 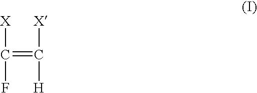
in which X and X′ can be, independently of one another, a hydrogen atom, a halogen, or a perhalogenated alkyl.

3. Multilayer structure according to claim 1, wherein said fluoropolymer is obtained by the radical polymerization of at least one fluoromonomer selected from the group consisting of vinylidene fluoride, vinyl fluoride, trifluoroethylene, tetrafluoroethylene, hexafluoropropylene, chlorotrifluoroethylene, 2-chloropentafluoro-propene, perfluoroalkyl vinyl ethers, 1-hydropenta-fluoropropene, 2-hydropentafluoropropene, dichlorodifluoro-ethylene, 1,1-dichlorofluoroethylene and perfluoro-1,3-dioxoles, perfluorodiallyl ether, perfluoro-1,3-butadiene and their mixtures.

4. Multilayer structure according to claim 1, wherein said fluoropolymer is obtained by the radical polymerization of at least one fluoromonomer selected from the group consisting of vinylidene fluoride, vinyl fluoride, trifluoroethylene, tetrafluoroethylene, hexafluoropropylene, chlorotrifluoroethylene, and mixtures thereof.

5. Multilayer structure according to claim 1, wherein said fluoropolymer is a homopolymer or a copolymer of vinylidene difluoride (VDF) containing at least 50 mole % VDF.

6. Multilayer structure according to claim 1, wherein said fluoropolymer is a copolymer of VDF and of at least one comonomer selected from the group consisting of vinyl fluoride, trifluoroethylene, tetrafluoroethylene (TFE), hexafluoropropylene (HFP), chlorotrifluoroethylene, 2-chloropentafluoro-propene, perfluoroalkyl vinyl ethers, 1-hydropentafluoropropene, 2-hydropenta-fluoropropene, dichlorodifluoroethylene, 1,1-dichlorofluoroethylene, perfluoro-1,3-dioxoles, fluorine-comprising diolefins.

7. Multilayer structure according to claim 1, wherein said fluoropolymer is a homopolymer or a copolymer of VDF and HFP or a terpolymer of VDF, HFP and TFE.

8. Multilayer structure according to claim 1, wherein said at least one functionalized fluoropolymer is a fluoropolymer comprising at least one fluoromonomer and at least one functional monomer having at least one double bond C═C and at least one functional group selected from carboxylic acid, carboxylic acid salt, carbonate, carboxylic acid anhydride, epoxide, carboxylic acid ester, silyl, alkoxysilane, carboxylic amide, hydroxyl, isocyanate.

9. Multilayer structure according to claim 1, wherein said at least one functionalized fluoropolymer is a any fluoropolymer comprising at least one fluoromonomer and at least one functional monomer selected from the group consisting of methacrylic acid; acrylic acid; undecylenic acid; zinc, calcium or sodium undecylenate; maleic anhydride; dichloromaleic anhydride; difluoromaleic anhydride; itaconic anhydride; citraconic anhydride; crotonic anhydride; glycidyl acrylate; glycidyl methacrylate; allyl glycidyl ether, vinylsilanes; vinyltrimethoxysilane; vinyltriethoxysilane; vinyltriacetoxysilane; and gamma-methacryloxypropyltrimethoxysilane.

10. Multilayer structure according to claim 9, wherein said functional monomer is maleic anhydride; or zinc, calcium and sodium undecylenates.

11. Multilayer structure according to claim 1, wherein said flexible fluoropolymer is a fluoropolymer having a tensile modulus between 200 and 600 Mpa.

12. Multilayer structure according to claim 1, wherein said flexible fluoropolymer is a fluoropolymer having a crystallization temperature from 50 to 120° C.

13. Multilayer structure according to claim 1, wherein the blend comprises from 10 to 90 parts of at least one functionalized polyvinyidene fluoride (PVDF) and from 90 to 10 parts a flexible fluoropolymer.

14. Multilayer structure according to claim 1, wherein the blend comprises from 10 to 50 parts of at least one functionalized PVDF and from 90 to 50 parts of a flexible fluoropolymer.

15. Multilayer structure according to claim 1, comprising in sucession:
a layer comprising said blend,
a layer comprising a thermoplastic polymer and optionally
a layer comprising said blend.

16. Multilayer structure according to claim 1, comprising in succession:
an inner layer comprising said blend and,
an outer layer comprising a thermoplastic polymer.

17. Multilayer structure according to claim 1, comprising in succession:
an inner layer comprising said blend,
an intermediate layer comprising a thermoplastic polymer and
an outer layer comprising said blend.

18. Multilayer structure according to claim 1, comprising in succession:
a layer comprising a fluoropolymer,
a layer comprising said blend and,
directly attached to the latter, a layer comprising a thermoplastic polymer.

19. Multilayer structure according to claim 1, comprising in succession:
an inner layer of PVDF,
optionally a layer comprising said blend,
a tie-layer,
an intermediate layer comprising a thermoplastic polymer,
a tie-layer,
an layer comprising said blend, and
optionally an outer layer of PVDF.

20. Multilayer structure according to claim 15, wherein the thermoplastic polymer is selected from polyethylenes, polypropylene, polyurethanes, polyamides, including polyamides 6, 6.6, 6. 10, 6. 12, 11 and 12, polyethylene terphthalate, polybutylene terephthalate, polyphenylene sulphide, polyoxymethylene (acetal) or ethylene/vinyl alcohol copolymers, including blends and co-polymers thereof.

21. Multilayer structure according to claim 15, which has the form of a bottle, tank, tube, pipe or container useful for storing and transporting chemicals.

22. Fuel tube or pipe comprising a multilayer according claim 1.
